(19) United States
(12) Patent Application Publication
(10) Pub. No.: US 2014/0335353 A1
(43) Pub. Date: Nov. 13, 2014

(54) VISCOELASTIC BODY

(71) Applicant: NITTO DENKO CORPORATION, Osaka (JP)

(72) Inventor: Youhei Maeno, Ibaraki-shi (JP)

(73) Assignee: NITTO DENKO CORPORATION, Osaka (JP)

(21) Appl. No.: 14/359,447

(22) PCT Filed: Oct. 5, 2012
(86) PCT No.: PCT/JP2012/075981

§ 371 Date: May 20, 2014

(30) Foreign Application Priority Data
Dec. 8, 2011 (JP) 2011-268980
Dec. 8, 2011 (JP) 2011-268981

(51) Int. Cl. C09J 1/00; C01B 31/02

(52) U.S. Cl. CPC C09J 1/00; C01B 31/022; Y10S 977/742; B82Y 30/00
USPC 428/367; 423/447.2; 977/742

(57) ABSTRACT

Provided is a viscoelastic body that has small tack, is excellent in handleability, and generates a small amount of outgas even under a high-temperature condition. Also provided is a viscoelastic body that has small tack, is excellent in handleability, and exhibits excellent viscoelasticity in a wide temperature range of from low temperature to high temperature. A viscoelastic body according to one embodiment of the present invention has an outgas amount of 20 mg/cm³ or less when stored at 400° C. for 1 hour. A viscoelastic body according to another embodiment of the present invention has a G′ in crimp type viscoelastic spectrum evaluation of 1.0×10⁶ Pa or less in a temperature range of from −150° C. to 500° C.

### TECHNICAL FIELD

The present invention relates to a viscoelastic body, and more particularly, to a viscoelastic body that generates a small amount of outgas and a viscoelastic body that exhibits excellent viscoelasticity in a wide temperature range.

### BACKGROUND ART

A viscoelastic body is useful as a material for a pressure-sensitive adhesive, and has been actively researched and developed in various industrial fields, by virtue of its excellent balance between elasticity and viscosity. Because of its low modulus, a pressure-sensitive adhesive formed of the viscoelastic body becomes wet to conform to an adherend, thereby expressing its pressure-sensitive adhesive strength.

Hitherto, an acrylic resin, a rubber-based resin, a silicone-based resin, or the like has been generally used as the material for a pressure-sensitive adhesive.

Hitherto, a high-molecular-weight substance of the organic material as described above has been used as the material for a pressure-sensitive adhesive. However, a solvent for increasing a molecular weight or a low-molecular-weight substance as a by-product remains in the pressure-sensitive adhesive. Therefore, when such material for a pressure-sensitive adhesive is used under a high-temperature condition or under a reduced-pressure or vacuum condition, or when the material is used in a closed space, the solvent or low-molecular-weight substance is generated as outgas, which causes problems such as generation of a bad smell, contamination of other materials, and degradation in pressure-sensitive adhesive property. Further, under the high-temperature condition, the organic material itself as described above is decomposed, and this decomposition also causes the problem of generation of outgas.

As a material for a pressure-sensitive adhesive that generates a reduced amount of outgas, for example, a specified cross-linked acrylic resin has been reported (see Patent Literature 1). However, this material is also a high-molecular-weight substance of the organic material as described above. Therefore, the material can merely reduce an amount of outgas to be generated when heated at 120° C. for 1 hour, and cannot reduce an amount of outgas to be generated under a higher temperature condition.

Further, hitherto, the high-molecular-weight substance of the organic material as described above has been used as the material for a pressure-sensitive adhesive. Thus, viscoelastic behavior varies depending on, for example, a melting point and glass transition temperature (Tg) of the high-molecular-weight substance (see Patent Literature 2). Therefore, for example, in the case of designing the material as a general-purpose pressure-sensitive adhesive, in general, the Tg is controlled to about −30° C. by material selection and the like and the viscoelastic behavior is adjusted so as to be constant at a G′ in crimp type viscoelastic spectrum evaluation of 1.0×10⁶ Pa or less in a temperature range of from about −30° C. to about 200° C.

However, in recent years, there have been increasing cases where a pressure-sensitive adhesive is used under a lower temperature condition or under a higher temperature condition. In addition, there is a problem in that the related-art material for a pressure-sensitive adhesive cannot exhibit satisfactory viscoelastic behavior in a wide temperature range of from lower temperature to higher temperature. Further, under the higher temperature condition, there is a problem in that the organic material itself as described above is decomposed.

In addition, the related-art viscoelastic body is difficult to handle because it easily adheres to a smooth surface owing to its strong tack.

### CITATION LIST

### Patent Literature

### [PTL 1] JP 2011-202126 A

### [PTL 2] JP 2010-168437 A

### SUMMARY OF INVENTION

### Technical Problem

It is an object of the present invention to provide a viscoelastic body that has small tack, is excellent in handleability and generates a small amount of outgas even under a high-temperature condition. Further, it is another object of the present invention to provide a viscoelastic body that has small tack, is excellent in handleability, and exhibits excellent viscoelasticity in a wide temperature range of from low temperature to high temperature.

### Solution to Problem

According to one embodiment of the present invention, there is provided a viscoelastic body, having an outgas amount of 20 mg/cm³ or less when stored at 400° C. for 1 hour.

According to one embodiment of the present invention, there is provided a viscoelastic body, having a G′ in crimp type viscoelastic spectrum evaluation of 1.0×10⁶ Pa or less in a temperature range of from −150° C. to 500° C.

In a preferred embodiment, in the viscoelastic body of the present invention, the G′ in crimp type viscoelastic spectrum evaluation at −150° C. and 500° C. falls within a range of from 0.01 times to 100 times a G′ in crimp type viscoelastic spectrum evaluation at 25° C.

In a preferred embodiment, the viscoelastic body of the present invention has a probe tack in a probe tack test of 200 gf or less at 25° C.

In a preferred embodiment, the viscoelastic body of the present invention includes a fibrous columnar structure.

In a preferred embodiment, the fibrous columnar structure includes a carbon nanotube aggregate including a plurality of carbon nanotubes.

In a preferred embodiment, the length of each of the carbon nanotubes is 50 μm or more.

In a preferred embodiment, the viscoelastic body of the present invention includes a base material.

In a preferred embodiment, the viscoelastic body of the present invention is used for an analytical instrument.

### Advantageous Effects of Invention

According to one embodiment of the present invention, it is possible to provide the viscoelastic body that has small tack, is excellent in handleability, and generates a small amount of outgas even under a high-temperature condition. Further, according to another embodiment of the present invention, it is possible to provide the viscoelastic body that has small tack, is excellent in handleability, and exhibits excellent viscoelasticity in a wide temperature range of from low temperature to high temperature.

### BRIEF DESCRIPTION OF DRAWINGS

FIG. 1 is a schematic sectional view of an example of a case where a viscoelastic body in a preferred embodiment of the present invention includes a carbon nanotube aggregate.

FIG. 2 is a schematic sectional view of an apparatus for producing a carbon nanotube aggregate in the case where a viscoelastic body in a preferred embodiment of the present invention includes a carbon nanotube aggregate.

### DESCRIPTION OF EMBODIMENTS

### <<Viscoelastic Body>>

A viscoelastic body according to one preferred embodiment of the present invention has an outgas amount of 20 mg/cm³ or less when stored at 400° C. for 1 hour. The outgas amount is preferably 10 mg/cm³ or less, more preferably 5 mg/cm³ or less, still more preferably 1 mg/cm³ or less.

The outgas amount when stored at 400° C. for 1 hour can be reduced to the above-mentioned level. Therefore, even in the case where the viscoelastic body of the present invention is used under a high-temperature condition or under a reduced-pressure or vacuum condition, the generation of outgas can be suppressed sufficiently, and the problems such as the generation of a bad smell, contamination of other materials, and degradation in pressure-sensitive adhesive property can be solved.

A viscoelastic body according to another preferred embodiment of the present invention has a G′ in crimp type viscoelastic spectrum evaluation of 1.0×10⁶ Pa or less in a temperature range of from −150° C. to 500° C. The G′ is preferably from 1.0×10² Pa to 5.0×10⁵ Pa, more preferably from 1.0×10³ Pa to 5.0×10⁵ Pa, still more preferably from 1.0×10⁴ Pa to 1.0×10⁵ Pa.

When the G′ in crimp type viscoelastic spectrum evaluation falls within the above-mentioned range in a temperature range of from −150° C. to 500° C., the viscoelastic body of the present invention can exhibit excellent viscoelasticity in a wide temperature range of from low temperature to high temperature.

In the viscoelastic body of the present invention, it is preferred that the G′ in crimp type viscoelastic spectrum evaluation at −150° C. and 500° C. fall within a range of from 0.01 times to 100 times a G′ in crimp type viscoelastic spectrum evaluation at 25° C. This range is preferably a range of from 0.1 times to 50 times, more preferably from 1 time to 10 times. When the G′ in crimp type viscoelastic spectrum evaluation at −150° C. and 500° C. falls within the above-mentioned range with respect to the G′ in crimp type viscoelastic spectrum evaluation at 25° C., the viscoelastic body of the present invention can exhibit excellent viscoelasticity in a wide temperature range of from low temperature to high temperature.

The viscoelastic body of the present invention has a probe tack in a probe tack test of preferably 200 gf or less, more preferably from 10 gf to 200 gf, still more preferably from 20 gf to 195 gf, particularly preferably from 30 gf to 190 gf at 25° C. In the present invention, the probe tack falls within the above-mentioned range, and hence the viscoelastic body of the present invention has moderate tack and is satisfactory in handleability.

The viscoelastic body of the present invention is preferably capable of selectively picking a particle having a specified particle diameter. Herein, the term “particle diameter” in the present invention refers to a portion with the smallest diameter of a particle.

The viscoelastic body of the present invention is preferably capable of selectively picking particles each having a particle diameter of less than 500 μm by adhesion. Herein, the term “picking particles by adhesion” in the present invention refers to picking particles serving as an adherend by crimping the viscoelastic body of the present invention to the particles to cause the particles to adhere to the viscoelastic body. The degree of the crimping may be appropriately set depending on purposes, and for example, there is given crimping by one reciprocation of a 5-kg roller.

The viscoelastic body of the present invention is preferably capable of selectively picking particles each having a particle diameter of 200 μm or less by adsorption. Herein, the term “picking particles by adsorption” in the present invention refers to picking particles serving as an adherend by causing the particles to adsorb to the viscoelastic body without crimping the viscoelastic body of the present invention to the particles. Specifically, for example, particles serving as an adherend are caused to adsorb to a viscoelastic body by bringing the particles into contact with the viscoelastic body at a small collision speed (for example, 1 m/s).

In the viscoelastic body of the present invention, a contained gas component may be removed as needed in a high-temperature environment or in a reduced-pressure environment or a vacuum environment in advance before use. The viscoelastic body of the present invention is less likely to lose its properties as the viscoelastic body even when exposed to a high-temperature environment or to a reduced-pressure environment or a vacuum environment in advance before use as described above.

The viscoelastic body of the present invention preferably includes a fibrous columnar structure.

Any appropriate material may be adopted as a material for the fibrous columnar structure. Examples thereof include: metals such as aluminum and iron; inorganic materials such as silicon; carbon materials such as a carbon nanofiber and a carbon nanotube; and high-modulus resins such as an engineering plastic and a super engineering plastic. Specific examples of the resins include polystyrene, polyethylene, polypropylene, polyethylene terephthalate, acetylcellulose, polycarbonate, polyimide, and polyamide. Any appropriate physical property may be adopted as each of various physical properties of any such resin such as a molecular weight as long as the objects of the present invention can be achieved.

The length of the fibrous columnar structure is preferably from 1 μm to 10,000 μm, more preferably from 10 μm to 5,000 μm, still more preferably from 30 μm to 3,000 μm, particularly preferably from 50 μm to 2,000 μm, most preferably from 100 μm to 2,000 μm. When the length of the fibrous columnar structure falls within the above-mentioned range, a viscoelastic body that has small tack, is excellent in handleability, and generates a small amount of outgas even under a high-temperature condition can be provided. Further, a viscoelastic body that has small tack, is excellent in handleability, and exhibits excellent viscoelasticity in a wide temperature range of from low temperature to high temperature can be provided.

The diameter of the fibrous columnar structure is preferably from 0.3 nm to 2,000 nm, more preferably from 1 nm to 1,000 nm, still more preferably from 2 nm to 500 nm. When the diameter of the fibrous columnar structure falls within the above-mentioned range, a viscoelastic body that has small tack, is excellent in handleability, and generates a small amount of outgas even under a high-temperature condition can be provided. Further, a viscoelastic body that has small tack, is excellent in handleability, and exhibits excellent viscoelasticity in a wide temperature range of from low temperature to high temperature can be provided.

In the present invention, the fibrous columnar structure is preferably a carbon nanotube aggregate including a plurality of carbon nanotubes.

The viscoelastic body of the present invention may be formed of only a carbon nanotube aggregate or may be formed of a carbon nanotube aggregate and any appropriate member.

The viscoelastic body of the present invention may include a base material. In this case, when the viscoelastic body of the present invention includes a carbon nanotube aggregate including a plurality of carbon nanotubes, one end of each of the carbon nanotubes may be fixed to the base material.

Any appropriate base material may be adopted as the base material depending on purposes. Examples thereof include quartz glass, silicon (such as a silicon wafer), an engineering plastic, and a super engineering plastic. Specific examples of the engineering plastic and the super engineering plastic include polyimide, polyethylene, polyethylene terephthalate, acetylcellulose, polycarbonate, polypropylene, and polyamide. Any appropriate physical property may be adopted as each of various physical properties such as a molecular weight of such base material as long as the objects of the present invention can be achieved.

The thickness of the base material may be set to any appropriate value depending on purposes. In the case of, for example, a silicon substrate, the thickness is preferably from 100 μm to 10,000 μm, more preferably from 100 μm to 5,000 μm, still more preferably from 100 μm to 2,000 μm. In the case of, for example, a polypropylene substrate, the thickness is preferably from 1 μm to 1,000 μm, more preferably from 1 μm to 500 μm, still more preferably from 5 μm to 100 μm.

The surface of the base material may be subjected to conventional surface treatment, e.g., chemical or physical treatment such as chromic acid treatment, exposure to ozone, exposure to a flame, exposure to a high-voltage electric shock, or ionizing radiation treatment, or coating treatment with an under coat (such as the above-mentioned adherent material) in order that adhesiveness with an adjacent layer, retentivity, or the like may be improved.

The base material may be a single layer, or may be a multilayer body.

When the viscoelastic body of the present invention includes a carbon nanotube aggregate including a plurality of carbon nanotubes and includes a base material, any appropriate method may be adopted as a method of fixing the carbon nanotubes to the base material. For example, a substrate used in the production of the carbon nanotube aggregate may be directly used as a base material. Further, a base material having formed thereon an adhesion layer may be fixed to the carbon nanotubes. Further, when the base material is a thermosetting resin, the fixing may be performed by producing a thin film in a state before a reaction, and crimping one end of each of the carbon nanotubes to the thin film layer, followed by curing treatment. In addition, when the base material is a thermoplastic resin or a metal, the fixing may be performed by crimping one end of the fibrous columnar structure to the base material in a molten state, followed by cooling to room temperature.

### <<Carbon Nanotube Aggregate>>

When the viscoelastic body of the present invention includes a fibrous columnar structure, the fibrous columnar structure is preferably a carbon nanotube aggregate. When the viscoelastic body of the present invention includes a carbon nanotube aggregate, the viscoelastic body of the present invention has small tack, is additionally excellent in handleability, and generates an additionally small amount of outgas even under a high-temperature condition. Further, when the viscoelastic body of the present invention includes a carbon nanotube aggregate, the viscoelastic body of the present invention has small tack, is additionally excellent in handleability, and exhibits additionally excellent viscoelasticity in a wide temperature range of from low temperature to high temperature.

### <<Carbon Nanotube Aggregate>>

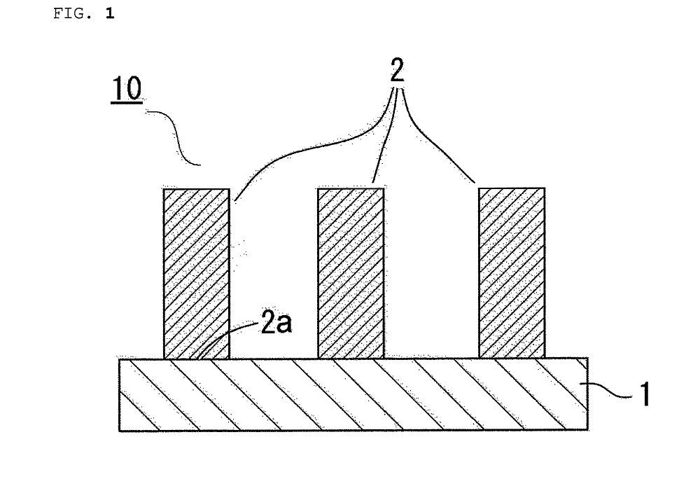

FIG. 1 is a schematic sectional view illustrating an example of a case where a viscoelastic body in a preferred embodiment of the present invention is a carbon nanotube aggregate (the view is not precisely illustrated to scale in order that each constituent portion may be clearly illustrated). A carbon nanotube aggregate 10 includes a base material 1 and carbon nanotubes 2. One end 2a of each of the carbon nanotubes 2 is fixed to the base material 1. The carbon nanotubes 2 are aligned in a lengthwise direction L. The carbon nanotubes 2 are preferably aligned in a direction substantially perpendicular to the base material 1. It should be noted that, even in the case where the carbon nanotubes are provided with no base material unlike this illustrated example, the carbon nanotubes may exist together as an aggregate by virtue of a van der Waals force, and hence the carbon nanotube aggregate of the present invention may be an aggregate including no base material.

In the case where the carbon nanotubes are provided with the base material in the carbon nanotube aggregate, any appropriate base material maybe adopted as the base material depending on purposes. As such base material, for example, there are given the base materials as described above that may be included in the viscoelastic body of the present invention.

### First Preferred Embodiment

A preferred embodiment (hereinafter sometimes referred to as “first preferred embodiment”) of the carbon nanotube aggregate that may be included in the viscoelastic body of the present invention includes a plurality of carbon nanotubes, in which: the carbon nanotubes each have a plurality of walls; the distribution width of the wall number distribution of the carbon nanotubes is 10 walls or more; the relative frequency of the mode of the wall number distribution is 25% or less; and the length of each of the carbon nanotubes is more than 10 μm.

The distribution width of the wall number distribution of the carbon nanotubes is 10 walls or more, preferably from 10 walls to 30 walls, more preferably from 10 walls to 25 walls, still more preferably from 10 walls to 20 walls.

The “distribution width” of the wall number distribution of the carbon nanotubes refers to a difference between the maximum wall number and minimum wall number in the wall numbers of the carbon nanotubes. When the distribution width of the wall number distribution of the carbon nanotubes falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate maybe used to provide a viscoelastic body that can express excellent viscoelasticity.

The wall number and the wall number distribution of the carbon nanotubes may be measured with any appropriate device. The wall number and wall number distribution of the carbon nanotubes are preferably measured with a scanning electron microscope (SEM) or a transmission electron microscope (TEM). For example, at least 10, preferably 20 or more carbon nanotubes may be taken out from a carbon nanotube aggregate to evaluate the wall number and the wall number distribution by the measurement with the SEM or the TEM.

The maximum wall number of the carbon nanotubes is preferably from 5 to 30, more preferably from 10 to 30, still more preferably from 15 to 30, particularly preferably from 15 to 25.

The minimum wall number of the carbon nanotubes is preferably from 1 to 10, more preferably from 1 to 5.

When the maximum wall number and minimum wall number of the carbon nanotubes fall within the above-mentioned ranges, the carbon nanotubes can bring together additionally excellent mechanical properties and a high specific surface area, and moreover, the carbon nanotubes can provide a carbon nanotube aggregate exhibiting additionally excellent pressure-sensitive adhesive property. Thus, such carbon nanotube aggregate may be used to provide a viscoelastic body that can express excellent viscoelasticity.

The relative frequency of the mode of the wall number distribution is 25% or less, preferably from 1% to 25%, more preferably from 5% to 25%, more preferably from 10% to 25%, particularly preferably from 15% to 25%. When the relative frequency of the mode of the wall number distribution falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate may be used to provide a viscoelastic body that can express excellent viscoelasticity.

The mode of the wall number distribution is present at a wall number of preferably from 2 to 10, more preferably from 3 to 10. When the mode of the wall number distribution falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate may be used to provide a viscoelastic body that can express excellent viscoelasticity.

Regarding the shape of each of the carbon nanotubes, the lateral section of the carbon nanotube has only to have any appropriate shape. The lateral section is of, for example, a substantially circular shape, an oval shape, or an n-gonal shape (n represents an integer of 3 or more).

The specific surface area and density of each of the carbon nanotubes may be set to any appropriate values.

### Second Preferred Embodiment

Another preferred embodiment (hereinafter sometimes referred to as “second preferred embodiment”) of the carbon nanotube aggregate that may be included in the viscoelastic body of the present invention includes a plurality of carbon nanotubes, in which: the carbon nanotubes each have a plurality of walls; the mode of the wall number distribution of the carbon nanotubes is present at a wall number of 10 or less; the relative frequency of the mode of the wall number distribution is 30% or more; and the length of each of the carbon nanotubes is more than 10 μm and less than 500 μm.

The distribution width of the wall number distribution of the carbon nanotubes is preferably 9 walls or less, more preferably from 1 walls to 9 walls, still more preferably from 2 walls to 8 walls, particularly preferably from 3 walls to 8 walls.

The “distribution width” of the wall number distribution of the carbon nanotubes refers to a difference between the maximum wall number and minimum wall number of the wall numbers of the carbon nanotubes. When the distribution width of the wall number distribution of the carbon nanotubes falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate maybe used to provide a viscoelastic body that can express excellent viscoelasticity.

The wall number and wall number distribution of the carbon nanotubes may be measured with any appropriate device. The wall number and wall number distribution of the carbon nanotubes are preferably measured with a scanning electron microscope (SEM) or a transmission electron microscope (TEM). For example, at least 10, preferably 20 or more carbon nanotubes may be taken out from a carbon nanotube aggregate to evaluate the wall number and the wall number distribution by the measurement with the SEM or the TEM.

The maximum wall number of the carbon nanotubes is preferably from 1 to 20, more preferably from 2 to 15, still more preferably from 3 to 10.

The minimum wall number of the carbon nanotubes is preferably from 1 to 10, more preferably from 1 to 5.

When the maximum wall number and minimum wall number of the carbon nanotubes fall within the above-mentioned ranges, the carbon nanotubes can each bring together additionally excellent mechanical properties and a high specific surface area, and moreover, the carbon nanotubes can provide a carbon nanotube aggregate exhibiting additionally excellent pressure-sensitive adhesive property. Thus, such carbon nanotube aggregate may be used to provide a viscoelastic body that can express excellent viscoelasticity.

The relative frequency of the mode of the wall number distribution is 30% or more, preferably from 30% to 100%, more preferably from 30% to 90%, still more preferably from 30% to 80%, particularly preferably from 30% to 70%. When the relative frequency of the mode of the wall number distribution falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate maybe used to provide a viscoelastic body that can express excellent viscoelasticity.

The mode of the wall number distribution is present at a wall number of 10 or less, preferably from 1 to 10, more preferably from 2 to 8, still more preferably from 2 to 6. In the present invention, when the mode of the wall number distribution falls within the above-mentioned range, the carbon nanotubes can bring together excellent mechanical properties and a high specific surface area, and moreover, the carbon nanotubes can provide a carbon nanotube aggregate exhibiting excellent pressure-sensitive adhesive property. Thus, such carbon nanotube aggregate may be used to provide a viscoelastic body that can express excellent viscoelasticity.

Regarding the shape of each of the carbon nanotubes, the lateral section of the carbon nanotube has only to have any appropriate shape. The lateral section is of, for example, a substantially circular shape, an oval shape, or an n-gonal shape (n represents an integer of 3 or more).

The specific surface area and density of each of the carbon nanotubes may be set to any appropriate values.

### <<Method of Producing Carbon Nanotube Aggregate>>

Any appropriate method may be adopted as a method of producing the carbon nanotube aggregate that may be included in the viscoelastic body of the present invention.

The method of producing the carbon nanotube aggregate that may be included in the viscoelastic body of the present invention is, for example, a method of producing a carbon nanotube aggregate aligned substantially perpendicularly from a smooth substrate by chemical vapor deposition (CVD) involving forming a catalyst layer on the substrate and filling a carbon source in a state in which a catalyst is activated with heat, plasma, or the like to grow the carbon nanotubes. In this case, the removal of the substrate provides a carbon nanotube aggregate aligned in a lengthwise direction.

Any appropriate substrate may be adopted as the substrate. The substrate is, for example, a material having smoothness and high-temperature heat resistance enough to resist the production of the carbon nanotubes. Examples of such material include quartz glass, silicon (such as a silicon wafer), and a metal plate made of, for example, aluminum. The substrate may be directly used as the substrate that may be included in the carbon nanotube aggregate that maybe included in the viscoelastic body of the present invention.

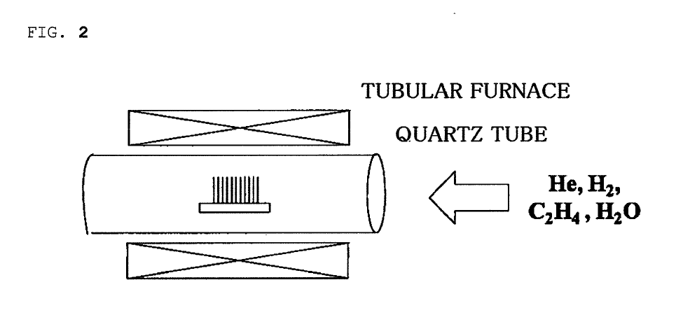

Any appropriate apparatus may be adopted as an apparatus for producing the carbon nanotube aggregate that may be included in the viscoelastic body of the present invention. The apparatus is, for example, a thermal CVD apparatus of a hot wall type formed by surrounding a cylindrical reaction vessel with a resistance heating electric tubular furnace as illustrated in FIG. 2. In this case, for example, a heat-resistant quartz tube is preferably used as the reaction vessel.

Any appropriate catalyst may be used as the catalyst (material for the catalyst layer) that may be used in the production of the carbon nanotube aggregate that may be included in the viscoelastic body of the present invention. Examples of the catalyst include metal catalysts such as iron, cobalt, nickel, gold, platinum, silver, and copper.

Upon production of the carbon nanotube aggregate that may be included in the viscoelastic body of the present invention, an alumina/hydrophilic film may be formed between the substrate and the catalyst layer as required.

Any appropriate method may be adopted as a method of producing the alumina/hydrophilic film. For example, the film may be obtained by producing an SiO₂ film on the substrate, depositing Al from the vapor, and increasing the temperature of Al to 450° C. after the deposition to oxidize Al. According to such production method, Al₂O₃ interacts with the hydrophilic SiO₂ film, and hence an Al₂O₃ surface different from that obtained by directly depositing Al₂O₃ from the vapor in particle diameter is formed. When Al is deposited from the vapor, and then its temperature is increased to 450° C. so that Al may be oxidized without the production of any hydrophilic film on the substrate, it may be difficult to form the Al₂O₃ surface having a different particle diameter. In addition, when the hydrophilic film is produced on the substrate and Al₂O₃ is directly deposited from the vapor, it may also be difficult to form the Al₂O₃ surface having a different particle diameter.

The catalyst layer that may be used in the production of the carbon nanotube aggregate that may be included in the viscoelastic body of the present invention has a thickness of preferably from 0.01 to 20 nm, more preferably from 0.1 to 10 nm in order that fine particles may be formed. When the thickness of the catalyst layer that may be used in the production of the carbon nanotube aggregate that may be included in the viscoelastic body of the present invention falls within the above-mentioned range, the carbon nanotube aggregate can bring together excellent mechanical properties and a high specific surface area, and moreover, the carbon nanotube aggregate can exhibit excellent pressure-sensitive adhesive property. Thus, such carbon nanotube aggregate may be used to provide a viscoelastic body that can express excellent viscoelasticity. Any appropriate method may be adopted as a method of forming the catalyst layer. Examples of the method include a method involving depositing a metal catalyst from the vapor, for example, with an electron beam (EB) or by sputtering and a method involving applying a suspension of metal catalyst fine particles onto the substrate.

Any appropriate carbon source may be used as the carbon source that may be used in the production of the carbon nanotube aggregate that maybe included in the viscoelastic body of the present invention. Examples thereof include: hydrocarbons such as methane, ethylene, acetylene, and benzene; and alcohols such as methanol and ethanol.

Any appropriate temperature may be adopted as a production temperature in the production of the carbon nanotube aggregate that may be included in the viscoelastic body of the present invention. For example, the temperature is preferably from 400° C. to 1,000° C., more preferably from 500° C. to 900° C., still more preferably from 600° C. to 800° C. in order that catalyst particles allowing sufficient expression of the effects of the present invention may be formed.

### <<Applications of Viscoelastic Body>>

The viscoelastic body may be used for various applications. The viscoelastic body of the present invention particularly has small tack, is excellent in handleability, and generates a small amount of outgas under a high-temperature condition or under a reduced pressure condition or a vacuum condition. Further, the viscoelastic body of the present invention particularly has small tack, is excellent in handleability, and exhibits excellent viscoelasticity in a wide temperature range of from low temperature to high temperature. Thus, the viscoelastic body of the present invention may be preferably used in, for example, the fields of analysis and superconductivity.

### EXAMPLES

Hereinafter, the present invention is described by way of Examples. However, the present invention is not limited thereto. It should be noted that various evaluations and measurements were performed by the following methods.

### <Evaluation of Wall Number and Wall Number Distribution of Carbon Nanotubes in Carbon Nanotube Aggregate>

The wall numbers and the wall number distribution of carbon nanotubes in the carbon nanotube aggregate of the present invention were measured with a scanning electron microscope (SEM) and/or a transmission electron microscope (TEM). At least 10, preferably 20 or more carbon nanotubes in the obtained carbon nanotube aggregate were observed with the SEM and/or the TEM to check the wall number of each carbon nanotube, and the wall number distribution was created.

### <Probe Tack Test>

A probe tack test was conducted under the following conditions to measure the maximum value of a pressure-sensitive adhesive strength.

Device: Tacking tester (manufactured by RESCA)
Probe: SUS 5 mmφ

### Preload: 500 gf

Press Speed: 1 mm/min

### Press Time: 5 s

Test Speed: 2.5 mm/min

### <Outgas Amount Measurement>

A viscoelastic body was placed in a sample cup and extracted by heating at 400° C. for 1 hour in a simulated air atmosphere with a heating furnace type pyrorizer (DSP). The gas generated at this time was concentrated and collected in a part of a GC column with liquid nitrogen through use of Microjet CryoTrap. Then, the resultant was subjected to GC/MS measurement to calculate an outgas amount per cm³.

### (Analysis Apparatus: GC/MS)

DSP: PY-20201D manufactured by Frontier Laboratories Ltd.
GC: Agilent 6890 manufactured by Agilent Technologies
MSD: Agilent 5973N manufactured by Agilent Technologies

### (Measurement Conditions)

Double-Shot Pyrolyzer (DSP)

Sample cup: Eco-cup LF

Heating temperature: 400° C.×1 h

Gas Chromatograph (GC)

Column: Ultla ALLOY+5 (0.25 μm, 0.25 mmφ×30 m) manufactured by Frontier Laboratories Ltd.

Column temperature: 40° C. (held for 3 min)→temperature increase at 15° C./min→300° C. (held for 10 min)

Carrier gas: He (1 ml/min) (constant flow mode)

Injection port: split mode (split ratio=10:1, total flow rate=13 ml/min, temperature: 300° C.)

Mass Spectrometer (MS)

Ionization method: EI

Ionization voltage: 70 eV

Interface temperature: 300° C.

Ion source temperature: 230° C.

Detector temperature: 150° C.

Measured mass range: m/z=10 to 800

TIC mass range: 29 to 800

### <Measurement of G′ in Crimp Type Viscoelastic Spectrum Evaluation>

A G′ was measured by performing crimp type viscoelastic spectrum evaluation under the following conditions.

### (Measurement Conditions)

Apparatus: strain control type rheometer “ARES-G2” manufactured by TA Instruments

Jig: compression jig of 8 mmφ

Measurement mode: temperature variance and tensile viscoelasticity

Temperature: from −150° C. to 500° C.

Frequency: 1 Hz

Strain: 1%

### Example 1

An Al thin film (thickness: 10 nm) was formed on a silicon wafer (manufactured by Silicon Technology Co., Ltd.) serving as a substrate with a sputtering device (RFS-200 manufactured by ULVAC Inc.). An Fe thin film (thickness: 0.35 nm) was deposited from the vapor on the Al thin film with the sputtering device (RFS-200 manufactured by ULVAC Inc.).

After that, the substrate was placed in a quartz tube of 30 mmφ, and a helium/hydrogen (90/50 sccm) mixed gas whose moisture was kept at 600 ppm was caused to flow through the quartz tube for 30 minutes to replace the inside of the quartz tube. Then, the inside of the quartz tube was increased in temperature to 765° C. through use of an electric tubular furnace and stabilized at 765° C. While the temperature was kept at 765° C., the inside of the quartz tube was filled with a helium/hydrogen/ethylene (85/50/5 sccm, moisture content: 600 ppm) mixed gas. The quartz tube was left to stand for 1 minute to grow carbon nanotubes on the substrate. Thus, a carbon nanotube aggregate (1) in which the carbon nanotubes were aligned in a lengthwise direction was obtained.

The length of each of the carbon nanotubes in the carbon nanotube aggregate (1) was 30 μm.

In the wall number distribution of the carbon nanotubes in the carbon nanotube aggregate (1), the mode was present at a wall number of 1, and the relative frequency was 61%.

The obtained carbon nanotube aggregate (1) was used for the viscoelastic body (1) and subjected to various evaluations, and the results were summarized in Table 1 and Table 2.

### Example 2

A carbon nanotube aggregate (2) in which carbon nanotubes were aligned in a lengthwise direction was obtained in the same way as in Example 1 except for setting the thickness of the Fe thin film to 1 nm.

The length of each of the carbon nanotubes in the carbon nanotube aggregate (2) was 30 μm.

In the wall number distribution of the carbon nanotubes in the carbon nanotube aggregate (2), the mode was present at a wall number of 2, and the relative frequency was 75%

The obtained carbon nanotube aggregate (2) was used for the viscoelastic body (2) and subjected to various evaluations, and the results were summarized in Table 1 and Table 2.

### Example 3

A carbon nanotube aggregate (3) in which carbon nanotubes were aligned in a lengthwise direction was obtained in the same way as in Example 2 except for leaving the quartz tube to stand for 3 minutes after the quartz tube was filled with the helium/hydrogen/ethylene (85/50/5 sccm, moisture content: 600 ppm) mixed gas.

The length of each of the carbon nanotubes in the carbon nanotube aggregate (3) was 50 μm.

In the wall number distribution of the carbon nanotubes in the carbon nanotube aggregate (3), the mode was present at a wall number of 2, and the relative frequency was 75%.

The obtained carbon nanotube aggregate (3) was used for the viscoelastic body (3) and subjected to various evaluations, and the results were summarized in Table 1 and Table 2.

### Example 4

A carbon nanotube aggregate (4) in which carbon nanotubes were aligned in a lengthwise direction was obtained in the same way as in Example 1 except for: setting the thickness of the Fe thin film to 2 nm; and leaving the quartz tube to stand for 5 minutes after the quartz tube was filled with the helium/hydrogen/ethylene (85/50/5 sccm, moisture content: 600 ppm) mixed gas.

The length of each of the carbon nanotubes in the carbon nanotube aggregate (4) was 70 μm.

In the wall number distribution of the carbon nanotubes in the carbon nanotube aggregate (4), the mode was present at wall numbers of 7 and 8, and the relative frequency was 66%.

The obtained carbon nanotube aggregate (4) was used for the viscoelastic body (4) and subjected to various evaluations, and the results were summarized in Table 1 and Table 2.

### Example 5

A carbon nanotube aggregate (5) in which carbon nanotubes were aligned in a lengthwise direction was obtained in the same way as in Example 1 except for: using acetylene in place of ethylene; and leaving the quartz tube to stand for 7 minutes after the quartz tube was filled with the helium/hydrogen/acetylene (85/50/5 sccm, moisture content: 600 ppm) mixed gas.

The length of each of the carbon nanotubes in the carbon nanotube aggregate (5) was 100 μm.

In the wall number distribution of the carbon nanotubes in the carbon nanotube aggregate (5), the mode was present at wall numbers of 7 and 8, and the relative frequency was 66%.

The obtained carbon nanotube aggregate (5) was used for the viscoelastic body (5) and subjected to various evaluations, and the results were summarized in Table 1 and Table 2.

### Example 6

A carbon nanotube aggregate (6) in which carbon nanotubes were aligned in a lengthwise direction was obtained in the same way as in Example 2 except for leaving the quartz tube to stand for 10 minutes after the quartz tube was filled with the helium/hydrogen/ethylene (85/50/5 sccm, moisture content: 600 ppm) mixed gas.

The length of each of the carbon nanotubes in the carbon nanotube aggregate (6) was 200 μm.

In the wall number distribution of the carbon nanotubes in the carbon nanotube aggregate (6), the mode was present at a wall number of 2, and the relative frequency was 75%.

The obtained carbon nanotube aggregate (6) was used for the viscoelastic body (6) and subjected to various evaluations, and the results were summarized in Table 1 and Table 2.

### Example 7

A carbon nanotube aggregate (7) in which carbon nanotubes were aligned in a lengthwise direction was obtained in the same way as in Example 1 except for leaving the quartz tube to stand for 20 minutes after the quartz tube was filled with the helium/hydrogen/ethylene (85/50/5 sccm, moisture content: 600 ppm) mixed gas.

The length of each of the carbon nanotubes in the carbon nanotube aggregate (7) was 400 μm.

In the wall number distribution of the carbon nanotubes in the carbon nanotube aggregate (7), the mode was present at a wall number of 1, and the relative frequency was 61%.

The obtained carbon nanotube aggregate (7) was used for the viscoelastic body (7) and subjected to various evaluations, and the results were summarized in Table 1 and Table 2.

### Example 8

A carbon nanotube aggregate (8) in which carbon nanotubes were aligned in a lengthwise direction was obtained in the same way as in Example 2 except for leaving the quartz tube to stand for 20 minutes after the quartz tube was filled with the helium/hydrogen/ethylene (85/50/5 sccm, moisture content: 600 ppm) mixed gas.

The length of each of the carbon nanotubes in the carbon nanotube aggregate (8) was 500 μm.

In the wall number distribution of the carbon nanotubes in the carbon nanotube aggregate (8), the mode was present at a wall number of 2, and the relative frequency was 75%.

The obtained carbon nanotube aggregate (8) was used for the viscoelastic body (8) and subjected to various evaluations, and the results were summarized in Table 1 and Table 2.

### Example 9

A carbon nanotube aggregate (9) in which carbon nanotubes were aligned in a lengthwise direction was obtained in the same way as in Example 4 except for leaving the quartz tube to stand for 40 minutes after the quartz tube was filled with the helium/hydrogen/ethylene (85/50/5 sccm, moisture content: 600 ppm) mixed gas.

The length of each of the carbon nanotubes in the carbon nanotube aggregate (9) was 800 μm.

In the wall number distribution of the carbon nanotubes in the carbon nanotube aggregate (9), the mode was present at a wall number of 3, and the relative frequency was 72%.

The obtained carbon nanotube aggregate (9) was used for the viscoelastic body (9) and subjected to various evaluations, and the results were summarized in Table 1 and Table 2.

### Example 10

A carbon nanotube aggregate (10) in which carbon nanotubes were aligned in a lengthwise direction was obtained in the same way as in Example 2 except for leaving the quartz tube to stand for 60 minutes after the quartz tube was filled with the helium/hydrogen/ethylene (85/50/5 sccm, moisture content: 600 ppm) mixed gas.

The length of each of the carbon nanotubes in the carbon nanotube aggregate (10) was 1,200 μm.

In the wall number distribution of the carbon nanotubes in the carbon nanotube aggregate (10), the mode was present at a wall number of 2, and the relative frequency was 75%.

The obtained carbon nanotube aggregate (10) was used for the viscoelastic body (10) and subjected to various evaluations, and the results were summarized in Table 1 and Table 2.

### Comparative Example 1

A double-coated pressure-sensitive adhesive tape (No. 5000N manufactured by Nitto Denko Corporation) was used as a viscoelastic body (C1) and subjected to various evaluations, and the results were summarized in Table 1 and Table 2.

### Comparative Example 2

A 3M polyimide double-coated tape (4390 manufactured by Sumitomo 3M Limited) was used as a viscoelastic body (C2) and subjected to various evaluations, and the results were summarized in Table 1 and Table 2.

### Comparative Example 3

A 3M polyimide double-coated tape (4390 manufactured by Sumitomo 3M Limited), which had been aged at 200° C. for 100 hours in advance, was used as a viscoelastic body (C3) and subjected to various evaluations, and the results were summarized in Table 1.

TABLE 1

| | Length of carbon | Probe | Outgas amount |
|---|---|---|---|
| | nanotube | tack | 400° C. × 1 hour |
| | (μm) | (gf) | (mg/cm³) |
| Example 1 | 30 | 39.6 | 0.41 |
| Example 2 | 30 | 42.1 | 0.50 |
| Example 3 | 50 | 62.8 | 0.28 |
| Example 4 | 70 | 74.1 | 0.31 |
| Example 5 | 100 | 127.2 | 0.35 |
| Example 6 | 200 | 144.0 | 0.21 |
| Example 7 | 400 | 189.7 | 0.34 |
| Example 8 | 500 | 213.6 | 0.30 |
| Example 9 | 800 | 225.7 | 0.29 |
| Example 10 | 1,200 | 211.9 | 0.26 |
| Comparative | 160 | 587.5 | 178.50 |
| Example 1 | | | |
| Comparative | 40/50 | 670.2 | 35.70 |
| Example 2 | | | |
| Comparative | 40/50 | 630.5 | 22.61 |
| Example 3 | | | |

TABLE 2

| | Thickness of | | | | |
|---|---|---|---|---|---|
| | pressure- | | | | |
| | sensitive | Probe | | | |
| | adhesive layer | tack | G′ (×10⁴) (Pa) | | |
| | (μm) | (gf) | −150° C. | 25° C. | 500° C. |
| Example 1 | 30 | 39.6 | 11.75 | 7.46 | 16.84 |
| Example 2 | 30 | 42.1 | 13.98 | 7.76 | 17.10 |
| Example 3 | 50 | 62.8 | 13.11 | 8.08 | 18.45 |
| Example 4 | 70 | 74.1 | 12.83 | 8.51 | 18.53 |
| Example 5 | 100 | 127.2 | 19.35 | 7.79 | 17.04 |
| Example 6 | 200 | 144.0 | 18.91 | 7.30 | 15.91 |
| Example 7 | 400 | 189.7 | 18.52 | 7.05 | 16.33 |
| Example 8 | 500 | 213.6 | 14.63 | 7.00 | 9.21 |
| Example 9 | 800 | 225.7 | 13.50 | 6.50 | 9.70 |
| Example 10 | 1,200 | 211.9 | 14.27 | 6.90 | 9.01 |
| Comparative | 160 | 587.5 | 87,200 | 5.45 | x |
| Example 1 | | | | | |
| Comparative | 40/50 | 670.2 | 45,400 | 4.87 | x |
| Example 2 | | | | | |

In the table, Symbol “x” means that measurement cannot be performed owing to the decomposition of an organic substance.

### INDUSTRIAL APPLICABILITY

The viscoelastic body of the present invention particularly has small tack, is excellent in handleability, and generates a small amount of outgas under a high-temperature condition or under a reduced-pressure condition or a vacuum condition. Further, the viscoelastic body of the present invention particularly has small tack, is excellent in handleability, and exhibits excellent viscoelasticity in a wide temperature range of from low temperature to high temperature. Thus, the viscoelastic body of the present invention may be preferably used in, for example, the fields of analysis and superconductivity.

### REFERENCE SIGNS LIST

10 carbon nanotube aggregate
1 base material
2 carbon nanotube
2a one end of carbon nanotube

1. A viscoelastic body, having an outgas amount of 20 mg/cm³ or less when stored at 400° C. for 1 hour.

2. A viscoelastic body, having a G′ in crimp type viscoelastic spectrum evaluation of 1.0×10⁶ Pa or less in a temperature range of from −150° C. to 500° C.

3. A viscoelastic body according to claim 2, wherein the G′ in crimp type viscoelastic spectrum evaluation at −150° C. and 500° C. falls within a range of from 0.01 times to 100 times a G′ in crimp type viscoelastic spectrum evaluation at 25° C.

4. A viscoelastic body according to claim 1, wherein the viscoelastic body has a probe tack in a probe tack test of 200 gf or less at 25° C.

5. A viscoelastic body according to claim 1, wherein the viscoelastic body comprises a fibrous columnar structure.

6. A viscoelastic body according to claim 5, wherein the fibrous columnar structure comprises a carbon nanotube aggregate including a plurality of carbon nanotubes.

7. A viscoelastic body according to claim 6, wherein a length of each of the carbon nanotubes is 50 μm or more.

8. A viscoelastic body according to claim 1, wherein the viscoelastic body comprises a base material.

9. A viscoelastic body according to claim 1, wherein the viscoelastic body is used for an analytical instrument.

10. A viscoelastic body according to claim 2, wherein the viscoelastic body has a probe tack in a probe tack test of 200 gf or less at 25° C.

11. A viscoelastic body according to claim 2, wherein the viscoelastic body comprises a fibrous columnar structure.

12. A viscoelastic body according to claim 11, wherein the fibrous columnar structure comprises a carbon nanotube aggregate including a plurality of carbon nanotubes.

13. A viscoelastic body according to claim 12, wherein a length of each of the carbon nanotubes is 50 μm or more.

14. A viscoelastic body according to claim 2, wherein the viscoelastic body comprises a base material.

15. A viscoelastic body according to claim 2, wherein the viscoelastic body is used for an analytical instrument.
